(19) United States
(12) Patent Application Publication
(10) Pub. No.: US 2014/0153080 A1
(43) Pub. Date: Jun. 5, 2014

(54) TWISTING BALL DISPLAYS COMPRISED OF THIXOTROPIC LIQUID AND BICHROMAL BALLS CHARGED WITH ELECTRET DIPOLES

(71) Applicants: Madis-Marius Vahtre, Tallinn (EE); Nicholas K. Sheridon, Los Altos, CA (US); Juri LIIV, Kuusalu (EE)

(72) Inventors: Madis-Marius Vahtre, Tallinn (EE); Nicholas K. Sheridon, Los Altos, CA (US); Juri LIIV, Kuusalu (EE)

(73) Assignee: VISITRET DISPLAYS OÜ, Tallinn (EE)

(21) Appl. No.: 13/578,193

(22) PCT Filed: Jun. 6, 2010
(86) PCT No.: PCT/EP2010/057865

§ 371 Date: Dec. 2, 2013

(30) Foreign Application Priority Data
Feb. 9, 2010 (EE) U201000017

(51) Int. Cl. G02B 26/02

(52) U.S. Cl. CPC G02B 26/026
USPC 359/296; 430/32

(57) ABSTRACT

This invention generally relates to the use of dipole charged balls having differently coloured hemispheres (bichromal balls) in twisting ball displays comprising a pair of planar addressing electrodes and the space between these electrodes that is filled with a thixotropic liquid into which has been dispersed a plurality of electrically charged and optically anisotropic rotatable elements.

### TECHNICAL FIELD

This invention generally relates to the use of dipole charged balls having differently coloured hemispheres (bichromal balls) in twisting ball displays, including Electronic Paper. Commercially realized prior art twisting ball displays utilized bichromal balls having both a dipole charge and a monopole charge.

### BACKGROUND ART

Twisting ball displays comprising bichromal balls having both dipole and monopole charging (Gyricon) have been extensively described in the literature, such as U.S. Pat. No. 4,126,854 by Sheridon titled “Twisting Ball Display”. The Gyricon display system consists of an elastomeric host layer of approximately 300 microns thickness that is heavily loaded with rotating elements, usually spheres, tens of micrometers in diameter (commonly 100 micrometers). Each rotating element has halves of contrasting colour, such as black and white. A dipole electret charge is associated with the coloured halves of the rotating element, so the black half might be positively charged and the white half might have the same magnitude of negative charge. In addition to this dipole charge the rotating element possesses a symmetrical distribution of charge of either positive or negative polarity, called a monopole charge. Such a ball placed in a uniform electric field will twist until its dipole charges are lined up with the external electric field; in other words the positively charged half will position itself to be closest to the negative electrode that creates the electric field and the negatively charged half will seek to rotate closer to the positive electrode. The monopole charge will cause the rotating element to translate in the electric field; if positive the element will move toward the negative electrode.

When placed in the elastomer layer each rotating element is situated in a somewhat larger cavity filled with oil, enabling the element to rotate in the electrical field. The element will also translate in the direction of the electrical field, causing the rotating element to move from one wall of the cavity where it adheres to the opposite wall where it will again adhere. The temporary adhesion of the rotating element to the cavity walls comprises a robust memory, enabled by the monopole charge. This behaviour is described in greater detail by Sheridon (“Flexible Flat Panel 5 Displays”, Gregory P. Crawford, Editor. John Wiley and Sons Ltd, Chichester, England)

### DISCLOSURE OF INVENTION

In the commercial embodiments of the twisting ball concept and in most of the patents the rotating elements, usually spheres or cylinders are individually contained within oil-filled cavities in a transparent elastomer sheet. This sheet is generally placed between a transparent conductive ground plane (the window) and an array of addressing electrodes. As mentioned above, prior art rotating elements have both a dipole and a monopole charge, enabling the elements to both rotate in their cavities and to move from one wall to the opposite wall. The monopole charge is seen to be essential for long-term memory of image information. It is further disclosed that there is a minimum value of monopole charge necessary to remove the element from its cavity wall, enabling it to freely rotate as it moves across the cavity. If the element has less than this minimum charge but a strong dipole the element will rotate in continuous contact with the cavity wall, preventing it from the 180 degree rotation necessary for good display contrast and brightness.

A further important function realized by constraining the rotating elements to their individual cavities has been found to be hydrodynamic isolation of the rotating elements from their neighbours. In the absence of this cavity system, as the elements rotate in response to an external field the liquid in the immediately surrounding neighbourhood also rotates, seriously disturbing the angular orientation of their neighbours and seriously interfering with their ability to also rotate a full 180 degrees. This is especially important in achieving high brightness for the display, which is proportional to the density of elements that can be placed in the top layer of the packed rotating elements. A higher packing density requires the distance between neighbours is minimized.

A further important function of the placement of the rotating elements in the elastomer sheet is the maintenance of the rotating element in their manufactured positions. The placement of elements is important to the appearance of the display, as indicated above.

In commercial examples of the twisting ball display the elastomer layer material has been found to be a major cost component. This material, which for reasons of transparency and excellent processing properties is generally a silicone rubber, is expensive in comparison to other components of the display system. Recent scientific literature has disclosed that very high values of permanent dipole polarization (called an electret) can obtain with certain materials. Notable among these materials are certain fluoropolymers. These materials can be fabricated as highly perfect spheres. The spheres can be given bichromal colour coatings and the permanent electrical dipoles can be induced by a strong external electrical field. The poles of the dipole can be made to coincide with the contrasting coloured halves of the bichromal balls. The use of rotating elements made from these materials is highly attractive because the strong dipole charge on the rotating elements will allow substantially lower addressing voltages. The available high level of sphericity of the rotating elements means they will require less space to rotate in than and therefore will allow closer packing of the balls, increasing the brightness and contrast of the display, as noted above.

Similar remarks pertain to the use of cylindrical rotating elements. In this invention the elastomer containment layer with its oil-filled cavities is replaced by a thixotropic dielectric liquid.

### DETAILED DESCRIPTION OF THE INVENTION

It is the object of this invention to provide means of both using rotating elements fabricated with only a dipole charge and eliminating the cost, high addressing voltages and processing requirements of the elastomer layer in making a display that continues to have the desirable feature of robust image storage and the improvements of lower addressing voltages, higher contrast and higher brightness. These and other improvements, including lower manufacturing costs, are obtained by dispersing the rotating elements in a dielectric liquid that has been previously made thixotropic by dispersing nanometer-sized silicon dioxide crystals into it. A thixotropic liquid has a viscosity that is controlled by external shear forces applied to it. In the absence of shear forces the viscosity is extremely high and as a result of shear forces the viscosity approaches the viscosity of the liquid the silicon dioxide was originally dispersed into. Upon the removal of said shear forces the viscosity can quickly revert to its high viscosity state. A minimum shear force or threshold force is required to convert the viscosity of a thixotropic liquid from the high viscosity state to the low viscosity state.

In practice the thixotropic liquid with the rotating elements dispersed in it might be injected into the space between the transparent conductive window of a display and the dielectric plate upon which the addressing electrodes have been configured. After the shear forces associated with the injection of this material into this space have been removed the rotating elements will be firmly locked into position, unable to translate or rotate. Upon the application of an external addressing voltage between an addressing electrode and the conductive window the dipole charge distribution in the rotating element experiences a torque that attempts to rotate it into alignment with the electrical field. Until the electrical addressing voltage is raised sufficiently high to overcome the threshold for viscosity conversion the rotating element will remain locked in place. Thresholded switching behaviour enables passive matrix addressing of such a display.

Upon application of a sufficiently strong electrical field a spherical rotating element will exert a torque on the surrounding thixotropic liquid. A spherical shell of thixotropic liquid very close to the surface of the sphere will experience an abrupt drop in viscosity, allowing rapid rotation of the sphere. The thickness of this shell will be determined in part by the sphericity of the sphere and the thickness of low viscosity liquid required to hydrodynamically accommodate the desired rotation rate. These will derive from the value of the address voltage. Effectively the sphere will rotate in its own spherical cavity and the hydrodynamics associated with its rotation will have little or no effect on adjacent spheres. A short while after the sphere rests in its new position the low viscosity shell of liquid that allowed its rotation will experience a huge increase in viscosity, locking the sphere into place. The sphere will neither be able to rotate or to translate. The thixotropic liquid thus provides a malleable containment structure that allows rotation of the spherical rotating elements but that holds the rotating elements in a fixed geometry.

It can be shown that if the rotating elements in a display are arranged in layers and if the maximum number of spheres is packed into each layer the brightness and contrast of the display are most strongly determined by the layer of spheres closest to an observer. The second layer of spheres is less important and if the spheres all have the same diameters (monodisperse) the third layer of spheres is of little value. Obviously, the best results obtain if the spheres are in touching contact with one another, however, this would guarantee that the rotation of one sphere would interfere with the stability of its neighbours. In some cases, then, it will be desirable to disperse into the thixotropic liquid spacer particles of size, geometry and numbers that will prevent the rotating elements from too close contact with one another. These should not adhere to the surfaces of the rotating elements but should remain uniformly dispersed in the thixotropic liquid. In fabricating displays with the use of thixotropic liquids it is useful to additionally disperse into the liquids spacer balls whose diameters equal the spacing between the transparent conductive window of the display and the sheet upon which the addressing elements are configured. This simplifies the fabrication of displays having flexible windows or substrates by defining the thickness of the active region of the display and is common practice in liquid crystal displays. While all commercial work with twisting ball displays has used an elastomer layer as a rotating element containment structure, other containment structures have been suggested. Sheridon described a containment structure consisting of a layer of dielectric liquid and a random network of fibers having the same refractive index as the liquid dispersed into the liquid layer. The rotating spheres would then be dispersed into the network of fibers and entangled by the fibers, which would maintain the spherical elements in the same spatial positions while allowing rotation. Long fibers of cellulose, nylon, etc were suggested and the difficult problem of uniformly entangling the rotating elements in the random mesh of fibers was not addressed. The intended fibers had diameters on the order of 25 microns and the rotating elements had diameters of from 100 to 400 microns. Therefore the number of fibers that could be in contact with the spheres at any time and thus the amount of drag force exerted by the fibers on the rotation of the spheres was a small number, giving rise to large statistical variations among spheres and therefore a large variation in the threshold voltage required for rotation. Additionally, the rotation of a given rotating element will hydrodynamically interfere with the stability and rotation of neighbouring elements since the viscosity of the dielectric liquid remains low in all places. In contrast, thixotropic particles are on the order of 8 nanometers in size. In fumed silica these particles tend to be sintered together end to end, forming extremely strong agglomerates on the order of 200 to 300 nanometers long. In the high viscosity state these permanent agglomerates have temporarily bonded to adjacent agglomerates, forming a network. This network strongly impedes the flow of liquid. If this network is subject to high external shear forces the temporary bonds will break, locally destroying the network and thus dropping the viscosity. When the external shear forces are removed the network will again form. The dielectric liquid viscosity is only low in the narrow shell adjacent to a sphere during rotation.

Thixotropic liquids can be highly transparent, because the silica particles are so much smaller than a wavelength of light. The refractive index of fumed silica is 1.46. The liquid refractive index can be adjusted to match this, providing even greater transparency. It can be seen that the thixotropic containment structure is entirely distinct from the fiber containment structure described by Sheridon. Engler et al have described a polymer containment structure comprising a collection of adjacent shells. Each shell is filled with oil and one or two bichromal spheres. The shell confines the spheres into a fixed geometry but allows rotation.

In order to obtain a threshold behaviour controlling the rotation of the spheres he replaces the dielectric liquid with a thixotropic liquid. Engler et al do not use the thixotropic liquid as a containment structure but as a viscosity modification to the oil contained in a containment structure. Engler et al go to the very considerable expense of building a complicated polymer containment structure and fail to recognize the potential of the thixotropic liquid as a low cost and easily implemented containment structure.

It is a further purpose of this application to disclose structures and methods of enabling the successful use in an elastomer layer of rotating elements that initially possess a dipole electret charge but no monopole charge. This is done by creating a permanent monopole charge in the rotating element before or during its infusion into the elastomer layer.

If an elastomer, such as the Sylgard 184, is cured in contact with a solid material, such as the material generally used to make the rotating elements, and subsequently pulled from that surface experiments have shown that there is left an electrical charge on the solid material surface and an equal and opposite electrical charge on the elastomer. Experiments have shown that this is a long-lived electrical charge and the magnitude of the charge is greater if the initial adhesion between the elastomer and the solid surface is also greater. The magnitude of this monopole charge can be controlled by fabricating the outer surface of the rotating elements with materials that have greater or lesser adhesion to the elastomer.

The elastomer layer is commonly made from Sylgard 184. In its uncured state this is a viscous liquid and the rotating elements are dispersed into it, then the suspension is formed into a thin layer having a thickness of several rotating element diameters. It is subsequently cured with the addition of heat. Finally the elastomer layer is plasticized by soaking in a dielectric liquid, such as silicone oil. This oil causes the elastomer layer to swell as it imbibes the oil. The rotating element does not imbibe the oil and thus does not swell. As the elastomer swelling progresses the elastomer is torn from all surfaces of the rotating element as a vacuum chamber forms around each rotating element. As a result the rotating element surface and the elastomer surface develop uniform monopole charges. The vacuum chamber quickly fills with oil, allowing easy rotation of the rotating element.

In addition to this charge, it is well known that a solid surface, such as that of the rotating element, in contact with a dielectric liquid develops a double layer charge. A charge develops on the solid surface, which is a measure of the chemical potential energy difference between the oil and the rotating element material. This charge is shielded by a cloud opposite polarity charges distributed in the liquid. Upon application of an external electrical field the mobile charges in the liquid are swept away leaving the charged surfaces of the rotating elements unshielded. These elements translate in the electrical field. The measure of the monopole charge on the on the rotating elements is called the zeta potential.

1-23. (canceled)

24. A method of enabling the precision addressing of the electrically charged and optically anisotropic elements of a twisting element display by dispersing said elements in a thixotropic liquid that provides hydrodynamic isolation between adjacent elements of said display.

25. The method according to claim 24 in which the degree of precision of addressing the elements is controlled by the concentration of the chemical used to produce the thixotropy, such as silicon dioxide.

26. A twisting ball display structure comprising the space between a pair of planar electrodes that is filled with a thixotropic liquid into which has been dispersed a plurality of electrically charged and optically anisotropic rotatable elements, the spacing of said rotatable elements being partially controlled by the co-dispersion of a greater plurality of smaller dimensioned particles.

27. The twisting ball display structure of claim 26 in which the said particles being transparent.

28. The twisting ball display structure of claim 27 in which the said particles having the same or nearly the same refractive index as the thixotropic liquid.

29. The twisting ball display structure of claim 26 in which the plurality of particles being sufficiently great that there is a low probability that any two said rotatable elements will touch one another.

30. The method of claim 26 in which a twisting ball display structure comprising the space between a pair of planar electrodes that is being filled with a thixotropic liquid into which has been dispersed a plurality of electrically charged and optically anisotropic rotatable elements, the spacing of said rotatable elements being partially controlled by the co-dispersion of a greater plurality of smaller dimensioned particles.

31. A twisting ball display structure comprising the space between a pair of planar addressing electrodes, said space being filled with a thixotropic liquid into which has been dispersed a plurality of rotatable electrically charged and optically anisotropic elements, means being provided to apply an AC electric field between the electrode pairs prior to addressing to cause a slight rotation of said elements, thereby lowering the threshold voltage for addressing.

32. The method according to claim 31 wherein the AC field is applied during addressing.

33. The method of claim 31 wherein the strength of the AC field is randomized over time over all addressing electrodes.

34. The display device structure comprising charged optically anisotropic rotatable elements dispersed in an elastomer layer and subsequently plasticized in an oil to form an oil filled cavity around each said element, the magnitude of the monopole charge on each rotatable element being controlled by the force needed to separate the ball surfaces from the elastomer during cavity formation.

35. The display device structure of claim 34 in which the degree of adhesion of the elastomer to the rotatable element surfaces is controlled by the chemistry of the elastomer and the rotatable elements.

36. The display device structure according to claim 34 in which the magnitude of the monopole charge is controlled by the rapidity of elastomer removal from the rotatable element surfaces.

37. The display device structure of claim 36 in which the rapidity of removal of the elastomer from the rotatable element surface is controlled by the viscosity and chemistry of the plasticizing liquid.

38. The display device structure of claim 37 in which the plasticizing liquid used to create the monopole charge is later replaced by a different plasticizing liquid.

39. The display device structure of claim 38 in which the first plasticizing liquid is volatile and the rapid removal of the elastomer from the rotatable element surface is augmented by application of a vacuum.

40. The method of claim 34 in which the display device structure comprising charged optically anisotropic rotatable elements dispersed in an elastomer layer and subsequently plasticized in an oil to form an oil filled cavity around each said element, the magnitude of the monopole charge on each rotatable element being controlled by the force needed to separate the ball surfaces from the elastomer during cavity formation.

41. The twisting ball display structure of claim 24 in which anisotropic element being bichromal spherical balls or cylinders.

42. The twisting ball display structure of claim 25 in which anisotropic element being bichromal spherical balls or cylinders.

43. The twisting ball display structure of claim 26 in which anisotropic element being bichromal spherical balls or cylinders.
